(19) United States
(12) Patent Application Publication
(10) Pub. No.: US 2014/0322376 A1
(43) Pub. Date: Oct. 30, 2014

(54) MOLDING MACHINE

(71) Applicant: JIH HUANG MACHINERY INDUSTRIAL CO., LTD., Tainan City (TW)

(72) Inventors: Ping-Jung LIN, Tainan City (TW); Po-Hung Lin, Tainan City (TW); Po-Hang Lin, Tainan City (TW)

(73) Assignee: JIH HUANG MACHINERY INDUSTRIAL CO., LTD., Tainan City (TW)

(21) Appl. No.: 14/074,718

(22) Filed: Nov. 8, 2013

(30) Foreign Application Priority Data
Apr. 24, 2013 (TW) 102114595

(51) Int. Cl. B29C 49/56; B29C 49/78

(52) U.S. Cl. CPC B29C 49/56; B29C 49/783
USPC 425/150; 425/541

(57) ABSTRACT

A molding machine includes a machine table, a mold unit and a pair of positioning units. The mold unit includes first and second molds mounted on the machine table and movable between a mold-closing position and a mold-opening position. The first and second molds abut against each other in the mold-closing position. Each of the positioning units includes a first positioner connected to the first mold, and a second positioner connected to the second mold. When the first and second molds are in the mold-closing position, the first and second positioners are operable to move to a locked state, where the first positioner is held by the second positioner to restrain the first and second molds from deforming away from each other.

### BACKGROUND OF THE INVENTION

1. Field of the Invention

The invention relates to a molding machine, more particularly to a molding machine for molding hollow containers.

2. Description of the Related Art

Taiwanese Patent No. I395654 discloses a conventional molding machine for molding hollow containers. The conventional molding machine includes first and second molds that are movable toward or away from each other. When the first and second molds are coupled together, they cooperatively define a molding apace therebetween, so that plastic raw material introduced into the molding space can be blown to form the containers. However, during a blow molding operation of the molding machine, due to high dynamic pressure induced upon blow molding, the first and second molds may deform and/or vibrate resulting in positional deviation of the molds, which adversely affects molding preciseness of the molding machine.

### SUMMARY OF THE INVENTION

Therefore, the object of the present invention is to provide a molding machine that includes a positioning unit for positioning molds in a mold-closing position with enhanced positioning and stabilizing forces in order to improve molding preciseness of the molding machine.

Accordingly, a molding machine of the present invention is provided. The molding machine includes a machine table, a mold unit, a drive unit and a pair of positioning units. The mold unit includes first and second molds that are mounted on the machine table and that are movable toward or away from each other in a first axis direction between a mold-closing position and a mold-opening position. The first and second molds abut against each other to define a molding space therebetween in the mold-closing position. The first and second molds are spaced apart from each other in the mold-opening position. The drive unit is mounted to the machine table for driving the first and second molds to move between the mold-closing position and the mold-opening position. The positioning units are disposed respectively at two sides of the mold unit and are spaced apart in a second axis direction perpendicular to the first axis direction. Each of the positioning units includes a first positioner that includes a lock member and that is connected to the first mold, and a second positioner that includes a clamp assembly and that is connected to the second molds. When the first and second molds are in the mold-closing position, the first and second positioners of each of the positioning units are operable to move from an unlocked state, where the lock member and the clamp assembly are spaced apart from each other, to a locked state, where the lock member moves to and is held by the clamp assembly to restrain the first and second molds from moving away from each other due to deformation therein resulting from a high air pressure in the molding space between the first and second molds during a blow molding operation of the molding machine.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary perspective view of a preferred embodiment of a molding machine according to the invention, illustrating the preferred embodiment in a mold-opening position;

FIG. 2 is another fragmentary perspective view of the preferred embodiment, illustrating the preferred embodiment in a mold-closing position;

FIG. 3 is a fragmentary side view of the preferred embodiment, illustrating the preferred embodiment in the mold-opening position;

FIG. 4 is another fragmentary side view of the preferred embodiment, illustrating the preferred embodiment in the mold-closing position;

FIG. 5 is an exploded fragmentary perspective view of a positioning unit of the preferred embodiment;

FIG. 6 is a fragmentary sectional view of the positioning unit of the preferred embodiment, illustrating the positioning unit in an unlocked state;

FIG. 7 is another fragmentary sectional view of the positioning unit of the preferred embodiment, illustrating the positioning unit in a locked state;

FIG. 8 illustrates an operation of the positioning unit from the unlocked state to the locked state; and

FIG. 9 is a fragmentary, partly sectional view of the preferred embodiment.

### DETAILED DESCRIPTION OF THE PREFERRED EMBODIMENT

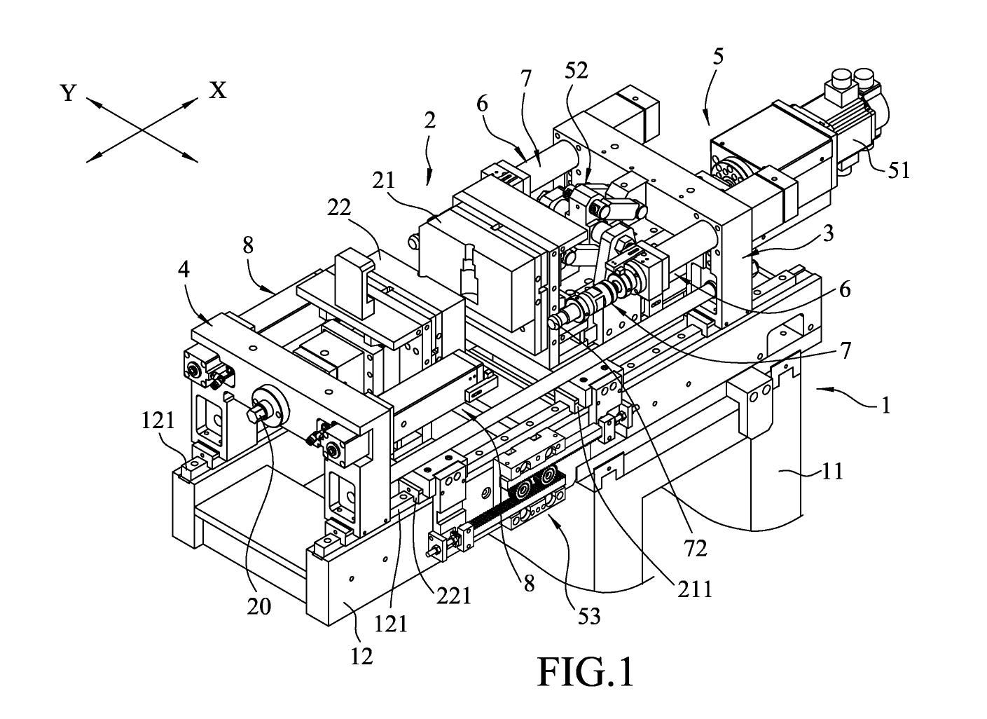

As shown in FIGS. 1 to 3, the preferred embodiment of the molding machine according to the present invention is adapted for making a hollow container, and includes a machine body 1, a mold unit 2, a first mounting seat 3, a second mounting seat 4, a drive unit 5, and a pair of positioning units 6.

The machine body 1 includes a base 11, and a machine table 12 disposed on the base 11. The machine table 12 includes a pair of elongated linear guide rails 121 that extend in a first axis direction (X) (i.e., a left-right direction of the machine body 1), and that are spaced apart from each other in a second axis direction (Y) (i.e., a front-rear direction of the machine body 1) perpendicular to the first axis direction (X).

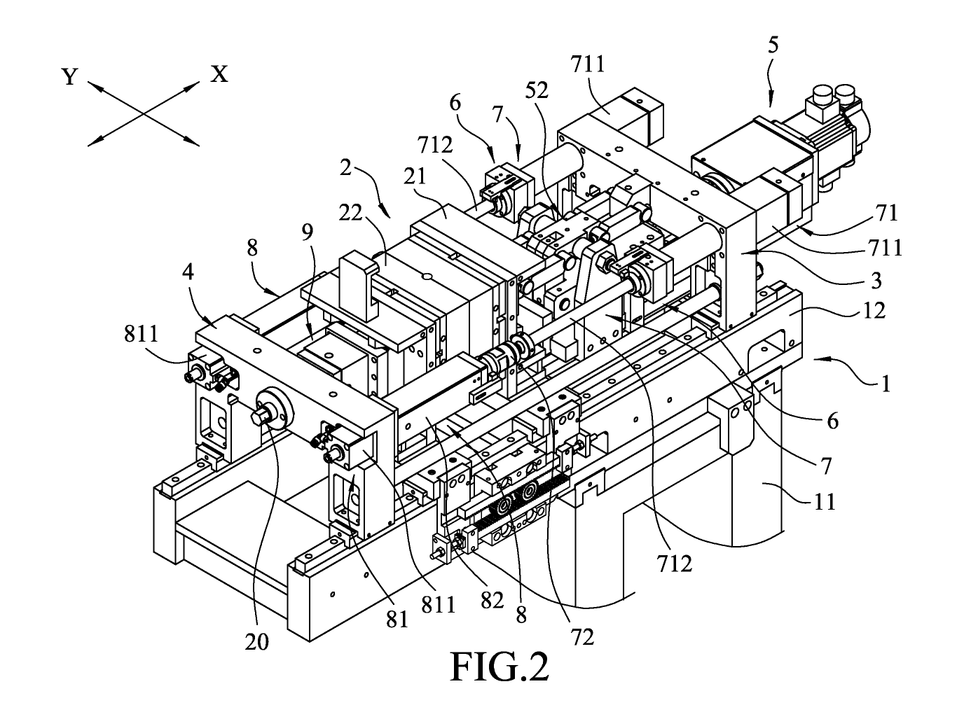

The mold unit 2 includes first and second molds 21, 22 that are mounted on the linear guide rails 121, and that are movable toward or away from each other in the first axis direction (X) between a mold-closing position (see FIG. 2) and a mold-opening position (see FIG. 1). The first mold 21 includes a pair of slide blocks 211 (only one is shown in FIG. 1) connected slidably and respectively to the linear guide rails 121. The second mold 22 includes a pair of slide blocks 221 (only one is shown in FIG. 1) connected slidably and respectively to the linear guide rails 121. The first and second molds 21, 22 abut against each other to define a molding space therebetween in the mold-closing position. Plastic raw material introduced into the molding space may be blown to form a hollow container. The first and second molds 21, 22 are spaced apart from each other in the mold-opening position.

The first and second mounting seats 3, 4 are mounted slidably to the linear guide rails 121. The first mounting seat 3 is spaced apart from one side of the first mold 21 distal from the second mold 22, is connected to the first mold 21, and moves oppositely of the first mold 21 when the first mold 21 moves. The second mounting seat 4 is spaced apart from one side of the second mold 22 distal from the first mold 21 and is connected co-movably to the second mold 22.

The drive unit 5 is mounted to the machine table 12, and includes a motor 51, a crank assembly 52 and a transmission assembly 53. The crank assembly 52 interconnects the first mold 21 and the first mounting seat 3, and is driven by the motor 51 to stretch or retract so as to move the first mold 21 and the first mounting seat 3 oppositely relative to each other. The transmission assembly 53 is connected to the first and second molds 21, 22. When the first mold 21 is moved by the crank assembly 52, the transmission assembly 53 drives the second mold 22 to move oppositely of the first mold 21.

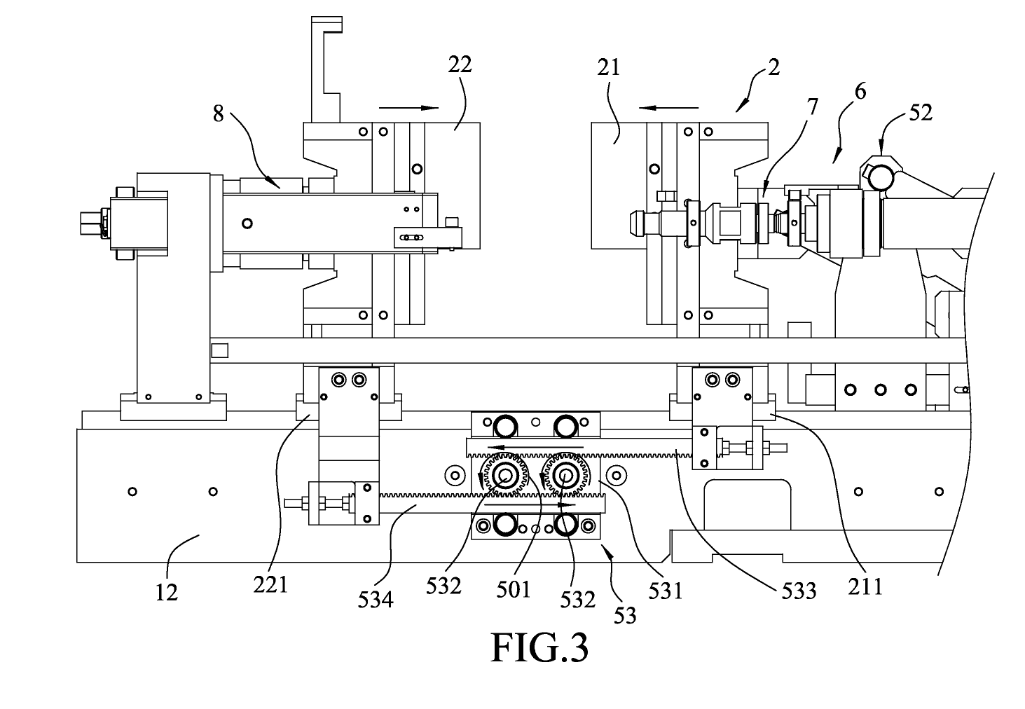

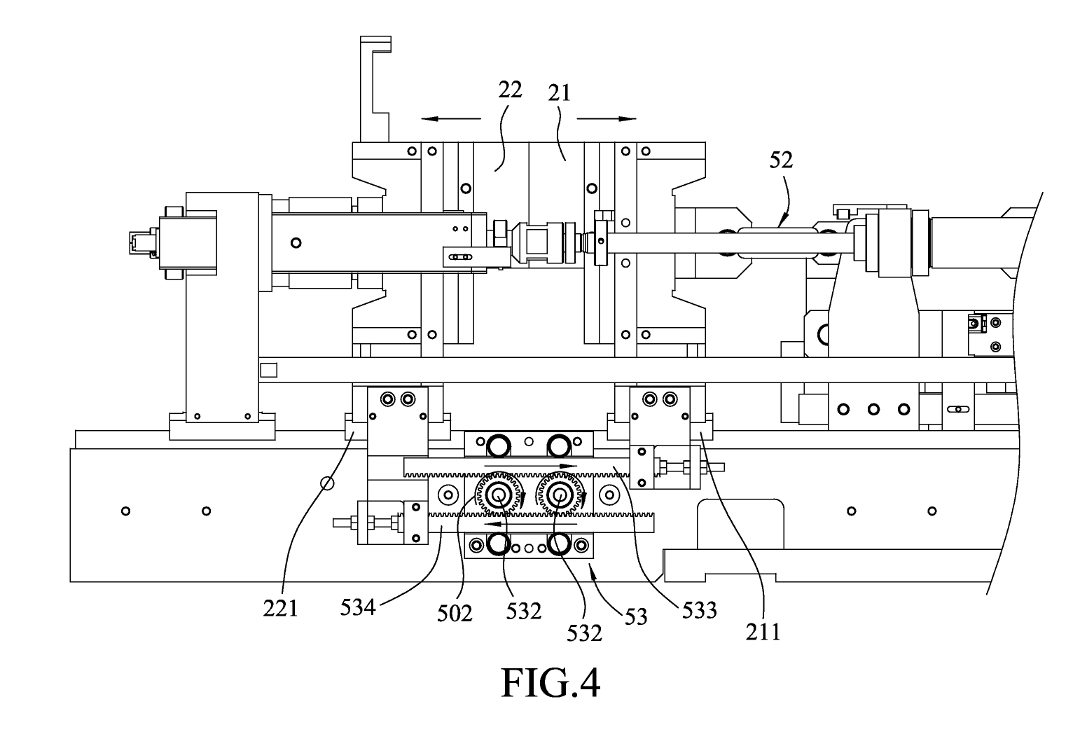

Referring to FIGS. 3 and 4, in detail, the transmission assembly 53 includes a pinion seat 531, two pinions 532, a first rack 533 and a second rack 534. The pinion seat 531 is mounted on one side of the machine table 12. The first rack 533 is connected co-movably to one of the slide blocks 211 of the first mold 21. The second rack 534 is connected co-movably to one of the slide blocks 221 of the second mold 22. Each of the pinions 532 is mounted rotatably on the pinion seat 531, and is disposed between and engaged with the first and second racks 533, 534. The second rack 534 is driven by the pinions 532 to move in a direction opposite to that of the first rack 533 when the pinions 532 are rotated by the first rack 533.

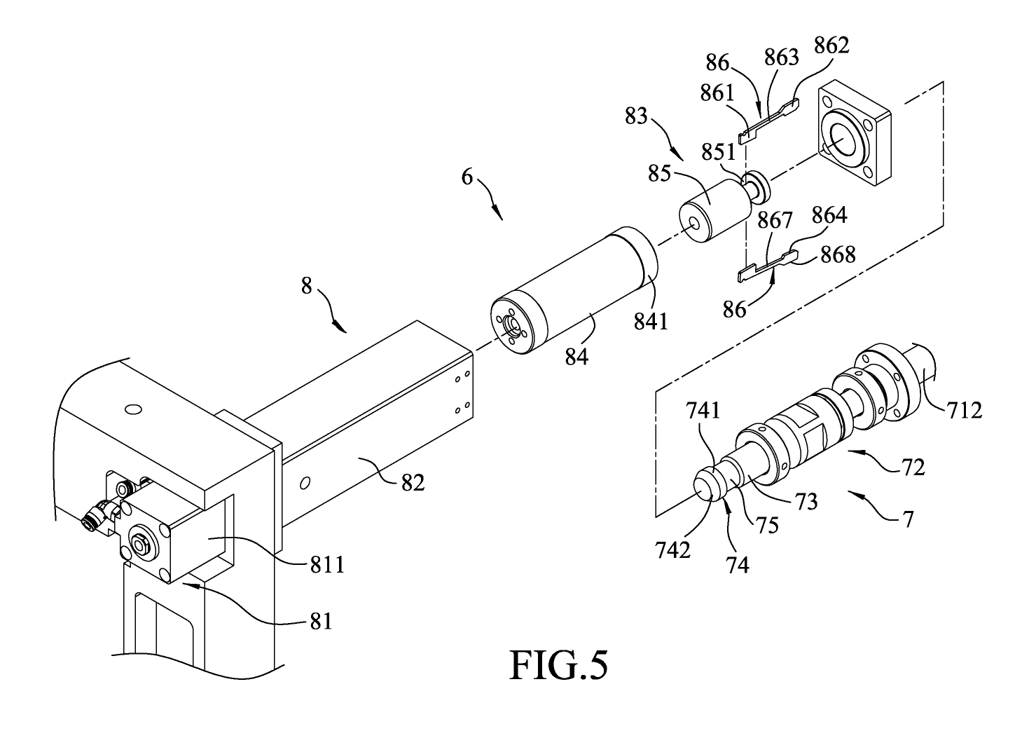

Referring to FIGS. 2, 5, and 6, the positioning units 6 are disposed respectively at two sides of the mold unit 2 that are opposite in the second axis direction (Y) (i.e., at front and rear sides of the mold unit 2). Each of the positioning units 6 includes a first positioner 7 co-movably mounted to the first mounting seat 3, and a second positioner 8 co-movably mounted to the second mounting seat 4 and aligned with the first positioner 7 in the first axis direction (X).

For each of the positioning units 6, the first positioner 7 includes a first pneumatic drive 71 and a lock member 72. The first pneumatic drive 71 has a cylinder body 711 mounted to the first mounting seat 3, and a piston rod 712 connected telescopically to the cylinder body 711. The piston rod 712 is stretchable outward of the cylinder body 711 to move toward the second positioner 8, and is retractable into the cylinder body 711 to move away from the second positioner 8. The lock member 72 is connected co-movably to the piston rod 712, and includes a main portion 73 connected to an outer distal end of the piston rod 712, an end head 74 spaced apart from the main portion 73 and directed toward the second positioner 8, and a neck portion 75 interconnecting the end head 74 and the main portion 73. The neck, portion 75 has a diameter smaller than those of the end head 74 and the main portion 73. The end head 74 has a cylindrical outer surface 741, a first annular guide surface 742 tapering from the cylindrical outer surface 741 in the first axis direction (X) and toward the second positioner 8, and a second annular guide surface 743 tapering from the cylindrical outer surface 741 toward the neck portion 75.

For each of the positioning units 6, the second positioner 8 includes a second pneumatic drive 81, a clamp seat 82, a clamp assembly 83 and a sleeve member 84. The clamp seat 82 is mounted to the second mounting seat 4, and defines an inner space 820 therein. The second pneumatic drive 81 has a cylinder body 811 mounted to the second mounting seat 4, and a piston rod 812 connected telescopically to the cylinder body 811 and extending through the second mounting seat 4 and into the inner space 820. The piston rod 812 is stretchable outward relative to the cylinder body 811 to move toward the first positioner 7 and retractable into the cylinder body 811 to move away from the first positioner 7. The clamp assembly 83 is disposed in the inner space 820, and includes a catcher seat 85, and a pair of spaced-apart catchers 86 connected to the catcher seat 85. The sleeve member 84 is connected co-movably to an outer distal end of the piston rod 812 and surrounds the catchers 86.

For the second positioner 8 of each of the positioning units 6, the catcher seat 85 of the clamp assembly 83 is disposed fixedly in the inner space 820 of the clamp seat 82 and has an annular engaging groove 851 formed in a surrounding surface thereof. The catchers 86 are movable toward or away from each other for clamping or releasing the lock member 72. Each of the catchers 86 has an engaging section 861 engaging movably the engaging groove 851, a head-clamping section 863 connected to one end of the engaging section 861 distal to the second mounting seat 4, and a neck-clamping section 862 connected to the head-clamping section 863 oppositely of the engaging section 861. The neck-clamping section 862 of each of the catchers 86 has a neck engaging surface 864 facing the neck engaging surface 864 of the other one of the catchers 86, a first slanting surface 865 extending from one end of the neck engaging surface 864 distal to the head-clamping section 863 of the catcher 86, a second slanting surface 866 extending from the other end of the neck engaging surface 864 proximal to the head-clamping section 863, and a sleeve engaging surface 868 opposite to the neck engaging surface 864. The first and second slanting surfaces 865, 866 extend divergingly in a direction from the neck engaging surface 864 toward the sleeve engaging surface 868. The head-clamping section 863 of each of the catchers 86 has a head engaging surface 867 facing the head engaging surface 867 of the other one of the catchers 86.

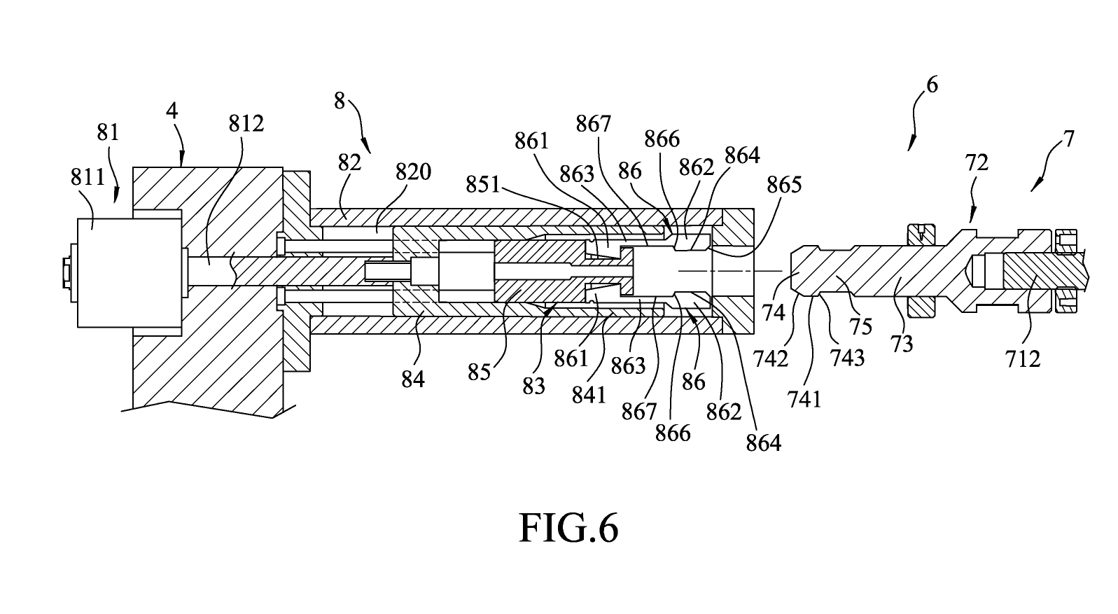

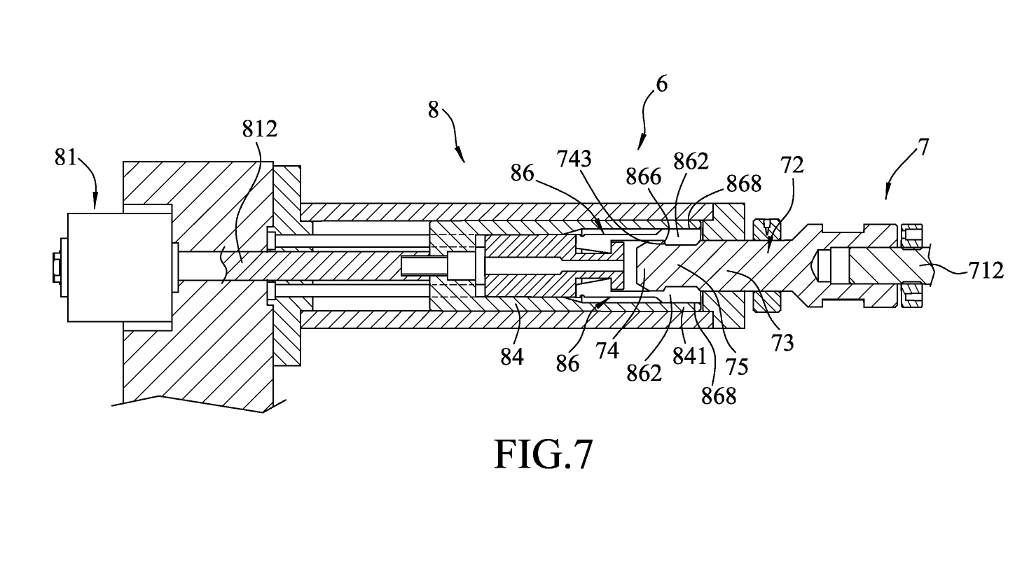

Referring to FIGS. 6 and 7, a distance between the head engaging surfaces 867 of the catchers 86 is equal to or slightly greater than a maximum outer diameter of the end head 74 of the lock member 72. A distance between the neck engaging surfaces 864 of the catchers 86 is smaller than the maximum outer diameter of the end head 74 and is equal to or slightly greater than the outer diameter of the neck portion 75.

The sleeve member 84 of the second positioner 8 of each of the positioning units 6 has a limiting annular portion 841 distal from the second piston rod 812 for sleeving removably around the neck-clamping sections 862 of the catchers 86 of the positioning unit 6 (see FIG. 7).

When the first and second molds 21, 22 are in the mold-opening position, the crank assembly 52 is retracted (see FIGS. 1 and 3). When the crank assembly 52 is driven by the motor 51 to stretch, the first mold 21 is thereby driven to move toward the second mold 22, and the first mounting seat 3 is driven to move oppositely of the first mold 21. Moreover, via the transmission unit 53, the second mold 22 and the second mounting seat 4 are driven to move toward the first mold 21 and to the mold-closing position (see FIGS. 2 and 4). The first and second positioners 7, 8 are moved along with the first and second mounting seats 3 and 4, respectively.

When the first and second molds 21, 22 are in the mold-closing position, the first and second positioners 7, 8 of each of the positioning units 6 are operable to move from an unlocked state, where the lock member 72 and the clamp assembly 83 are spaced apart from each other, to a locked state, where the lock member 72 is moved to and is clamped by the clamp assembly 83 to restrain the first and second molds 21, 22 from moving away from each other due to deformation therein resulting from a high air pressure in the molding space between the first and second molds 21, 22 during a blow molding operation of the molding machine.

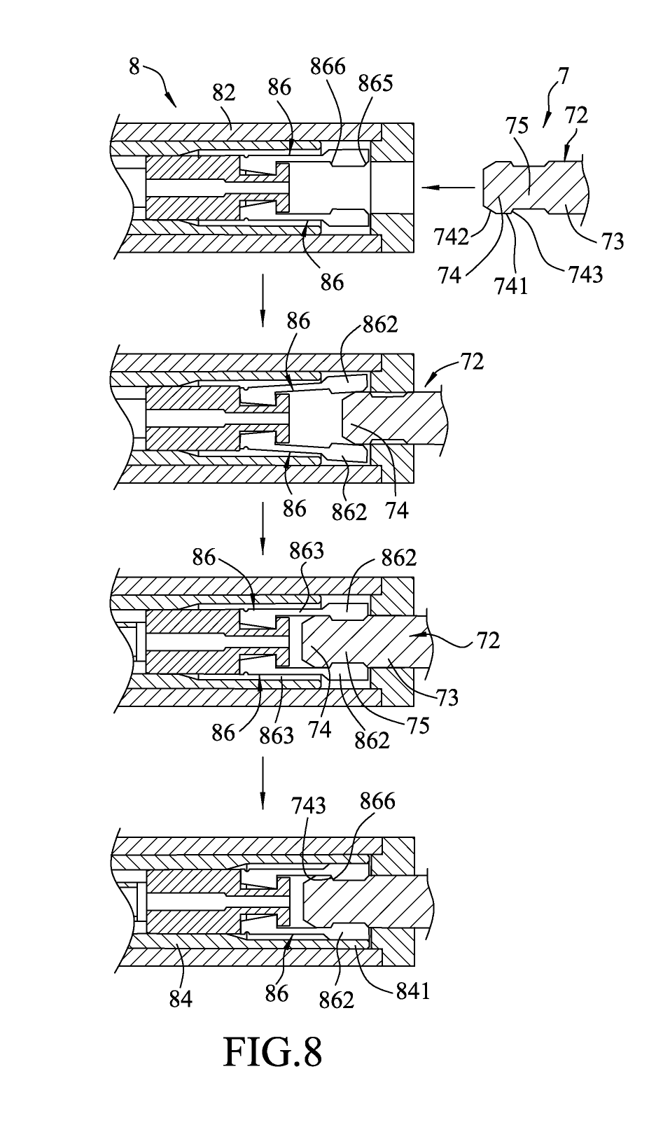

Referring to FIGS. 6 to 8, in the operation of the first and second positioners 7, 8 of each of the positioning units 6 to move from the unlocked state to the locked state, the lock member 72 is driven by the piston rod 712 of the first pneumatic cylinder 71 to move toward and contact the catchers 86 of the clamp assembly 83. With a further movement of the lock member 72 toward the clasp assembly 83, the first annular guide surface 742 of the end head 74 is guided by the first slanting surfaces 865 of the neck-clamping sections 862 of the catchers 86 to move into a space between the catchers 86 such that the neck-clamping sections 862 are pushed away from each other to permit the end head 74 to enter a space between the head-clamping sections 863. As a result, the neck portion 75 is clamped between the neck-clamping sections 862 and engages the neck engaging surfaces 864, and the end head 74 is clamped between the head-clamping sections 863 and engages the head engaging surfaces 867. Subsequently, the sleeve member 84 is driven by the piston rod 812 of the second pneumatic cylinder 81 to move to the neck-clamping sections 862 of the catchers 86 so that the limiting annular portion 841 of the sleeve member 84 sleeves around the neck-clamping sections 862 and limits the catchers 86 from moving away from each other. In this state, the limiting annular portion 841 of the sleeve member 84 engages the sleeve engaging surfaces 868.

By the abovementioned configuration, the lock member 72 of the first positioner 7 of each of the positioning units 6 is clamped firmly by the clamp assembly 83 of the second positioner 8 of the positioning unit 6. With the use of the first and second positioners 7 and 8, the problem of vibrational movements and positional deviation (deformation) of the first and second molds 21, 22 occurring during blow molding can be reduced.

When the molding process is finished and when the first and second positioners 7, 8 of each of the positioning units 6 are operated to move from the locked state to the unlocked state, the sleeve member 84 is first operated to move away from the neck-clamping sections 862 to permit the catchers 86 to move away from each other. Then the lock member 72 is driven to move away from the clamp assembly 83. During the movement of the lock member 72 away from the clamp assembly 83, the second annular guide surface 743 of the end head 74 is guided by the second slanting surfaces 866 of the neck-clamping sections 862 of the catchers 86 to cause the catchers 86 to move away from each other and to permit the end head 74 to exit the space between the catchers 86 and to move away from the clamp assembly 83.

Finally, the crank assembly 52 and the transmission unit 53 are operated to drive the first and second molds 21, 22 back to the mold-opening position.

Since the positioning units 6 are disposed respectively at front and rear sides of the mold unit 2, the first and second molds 21, 22 can be stabilized efficiently during the molding process. Therefore, the molding machine is able to provide an enhanced molding preciseness and the quality of the finished products (the hollow containers) produced by the molding machine may be improved.

In this embodiment, since the machine table 12 is propped up by the base 11, a conveying belt (not shown) can be disposed under the machine table 12. The hollow container made by the molding machine can be taken from the mold unit 2 by a robot arm (not shown) and placed on the conveying belt to be conveyed. Such layout enhances the exploitation of a limited space.

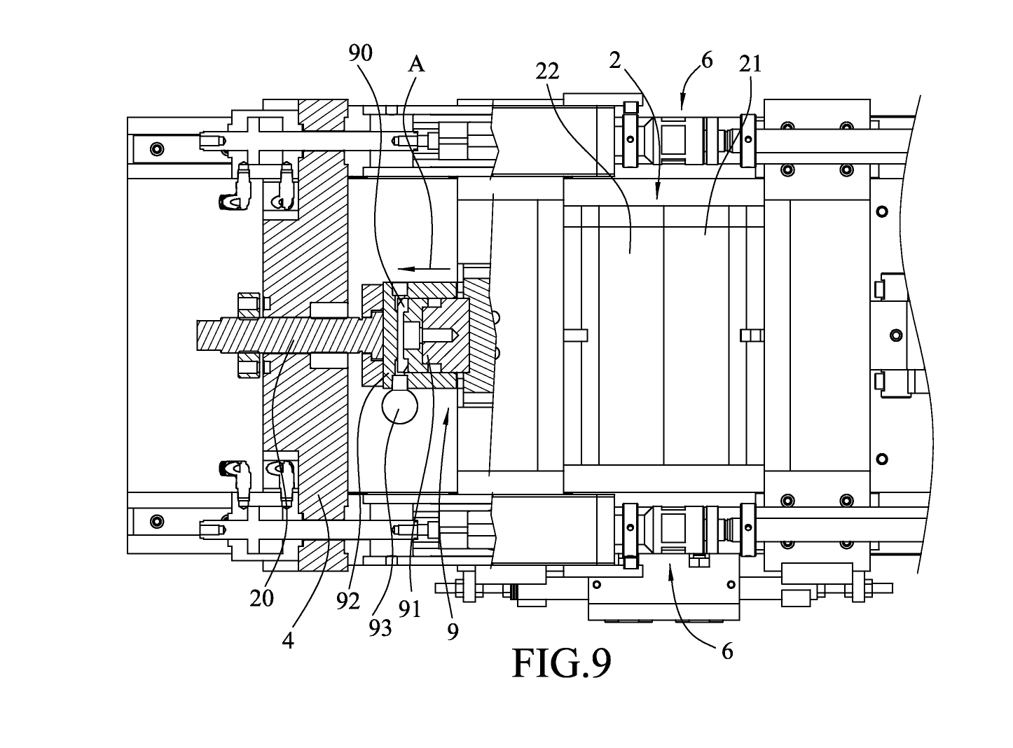

Referring to FIGS. 2 and 9, the second mold 22 is connected to the second mounting seat 4 via an adjusting screw 20. A position of the second mold 22 relative to the second mounting seat 4 is adjustable by operating the adjusting screw 20 to obtain the most suitable mold-closing pressure for the first and second molds 21, 22.

Moreover, the molding machine of this invention further includes a pressure detecting device 9 that includes a block 91, a fluid casing 92 and a pressure gauge 93. The fluid casing 92 is connected fixedly to the second mounting seat 4 and the second mold 22, and has an opening that opens toward the second mold 22. The block 91 is connected fixedly to the second mold 22 and extends fittingly into the fluid casing 92 to define a fluid space 90 therebetween. The fluid space 90 is filled with oil. The pressure gauge 93 is adapted for detecting a fluid pressure in the fluid space 90. When the first and second molds 21, 22 are closed to perform the blow molding operation, the second mold 22 may slightly deform in the way that the pressure detecting device 9 and the second mounting seat 4 is subjected to a force in the direction of the arrow (A) in FIG. 9 and the pressure in the fluid space 90 increases. The pressure gauge 93 detects the pressure in the fluid space 90, from which a blowing pressure may be obtained through calculation. If the blowing pressure is overly large or small, the adjusting screw 20 may be operated to adjust the position of the second mold 22 relative to the second mounting seat 4.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A molding machine comprising:
a machine table;
a mold unit including first and second molds that are mounted on said machine table and that are movable toward or away from each other in a first axis direction between a mold-closing position and a mold-opening position, said first and second molds abutting against each other to define a molding space therebetween in the mold-closing position, said first and second molds being spaced apart from each other in the mold-opening position;
a drive unit mounted to said machine table for driving said first and second molds to move between the mold-closing position and the mold-opening position; and
a pair of positioning units which are disposed respectively at two sides of said mold unit and which are spaced apart in a second axis direction perpendicular to the first axis direction, each of said positioning units including a first positioner that includes a lock member and that is connected to said first mold, and a second positioner that includes a clamp assembly and that is connected to said second mold;
wherein, when said first and second molds are in the mold-closing position, said first and second positioners of each of said positioning units are operable to move from an unlocked state, where said lock member and said clamp assembly are spaced apart from each other, to a locked state, where said lock member is held by said clamp assembly to restrain said first and second molds from moving away from each other due to deformation therein resulting from a high air pressure in said molding space between said first and second molds during a blow molding operation of said molding machine.

2. The molding machine as claimed in claim 1, wherein, for each of said positioning units:
said lock member of said first positioner has a main portion,
an end head spaced apart from, said main portion and directed toward said clamp assembly of said second positioner, and
a neck portion interconnecting said end head and said main portion; and
said clamp assembly includes a pair of spaced-apart catchers movable toward or away from each other for clamping or releasing said lock member, each of said catchers having a neck-clamping section and a head-clamping section connected to said neck-clamping section, said neck portion being clamped between said neck-clamping sections and said end head being clamped between said head-clamping sections when said first and second positioners are at the locked state.

3. The molding machine as claimed in claim 2, wherein, for each of said positioning units, said second positioner further includes a sleeve member disposed movably around said catchers, said sleeve member being moved to sleeve on said neck-clamping sections of said catchers to thereby limit said catchers from moving away from each other when said first and second positioners are at the locked state, and being movable away from said neck-clamping sections to thereby permit said catchers to move away from each other.

4. The molding machine as claimed in claim 3, wherein, for each of said positioning units:
said end head of said lock member of said first positioner has
a cylindrical outer surface,
a first annular guide surface tapering from said cylindrical outer surface in the first axis direction toward said second positioner, and
a second annular guide surface tapering from said cylindrical outer surface toward said neck portion; and
said neck-clamping section of each of said catchers has
a neck engaging surface engageable with said neck portion,
a first slanting surface extending from one end of said neck engaging surface distal to said head-clamping section,
a second slanting surface extending from the other end of said neck engaging surface proximal to said head-clamping section, and
a sleeve engaging surface opposite to said neck engaging surface and engageable with said sleeve member, said first and second slanting surfaces extending divergingly in a direction from said neck engaging surface toward said sleeve engaging surface.

5. The molding machine as claimed in claim 3, wherein, for each of said positioning units:
said first positioner further includes a first pneumatic cylinder that has a cylinder body, and a piston rod connected telescopically to said cylinder body and connected drivingly to said locking member; and
said second positioner further includes a second pneumatic cylinder that has a cylinder body, and a piston rod connected telescopically to said cylinder body and connected drivingly to said sleeve member.

6. The molding machine as claimed in claim 5, further comprising first and second mounting seats mounted on said machine table, said first mounting seat being spaced apart from one side of said first mold distal from said second mold, being connected to said first mold, and moving oppositely of said first mold when said first mold moves, said second mounting seat being spaced apart from one side of said second mold distal from said first mold and being connected co-movably to said second mold, said first pneumatic cylinder of said first positioner of each of said positioning units being mounted on said first mounting seat, said second pneumatic cylinder of said second positioner of each of said positioning units being mounted on said second mounting seat.

7. The molding machine as claimed in claim 1, wherein said drive unit includes
a motor,
a crank assembly driven by said motor and connected to said first mold to drive the movement of said first mold, and
a transmission assembly connected to said first and second molds, said transmission assembly driving said second mold to move oppositely of said first mold when said first mold is driven to move by said crank assembly.

8. The molding machine as claimed in claim 7, wherein said transmission assembly includes
a first rack connected co-movably to said first mold,
a second rack connected co-movably to said second mold, and
a pinion disposed between and engaged with said first and second racks, said second rack being driven by said pinion to move in a direction opposite to that of said first rack when said pinion is rotated by said first rack.

9. The molding machine as claimed in claim 6, further comprising a pressure detecting device that includes
a fluid casing connected fixedly to said second mounting seat and having an opening that opens toward said second mold,
a block connected fixedly to said second mold and extending fittingly into said fluid casing to define a fluid space therebetween, said fluid space being filled with liquid, and
a pressure gauge for detecting a fluid pressure in said fluid space when said first and second molds are in the mold-closing position.
